(19) United States
(12) Patent Application Publication
(10) Pub. No.: US 2005/0223832 A1
(43) Pub. Date: Oct. 13, 2005

(54) Actuator using spur gears

(76) Inventors: Zhihang Li, FoShan City (CN); Saili Li, Guangzhou (CN); Jinting Xue, Zhaoqing City (CN); Liming Tang, Zhaoqing (CN); Xu Du, Zhaoqing (CN); Joseph B. Benson, South Lyon, MI (US)

Correspondence Address: HUSCH & EPPENBERGER, LLC, 190 CARONDELET PLAZA, SUITE 600, ST. LOUIS, MO, 63105-3441, US

(21) Appl. No.: 10/817,122

(22) Filed: Apr. 2, 2004

(51) Int. Cl. F16H 1/20

(52) U.S. Cl. 74/425

(57) ABSTRACT

The invention is an electric motor actuator for use in heater, ventilator and air-conditioning systems in automobiles. The present invention comprises an electric motor, an output shaft on which a worm is rotatably mounted, a spur gear train, an output gear connected to a driver, an optical sensor, and a printed circuit board. The present invention is designed to provide an actuator that is simple and affordable to manufacture.

### BACKGROUND OF THE INVENTION

1. Field of the Invention

This invention relates generally to a motor actuator and, more particularly, to an electric motor actuator for heater, ventilator, and air-conditioning systems in automotives. This invention is designed with a plurality of spur gears.

2. Related Art

It is generally known in the art to provide a heater, ventilator and air-conditioning system in an automobile. It is also generally known in the art to provide electric motor actuators to drive flaps to control the air flow in these heater, ventilator and air-conditioning systems. However, there are a few problems with the actuators known in the art. Generally, these actuators are also not compact in structure nor do they contain a common actuator housing structure. In particular, Australian Patent Application No. 72145/00 discloses a flap actuator for use in heater, ventilator and air-conditioning systems in vehicles. However, the actuator disclosed in the Australian patent application does not have a high efficiency and creates significant noise due to its design. Moreover, the actuator disclosed in the Australian patent application does not use a plurality of spur gears.

### SUMMARY OF INVENTION

The present invention is an electric motor actuator designed with a plurality of spur gears for heater, ventilator and air-conditioning systems in automotives. The actuator comprises a motor with an output shaft, a worm rotatable on the output shaft, a gear train, an output gear, an optical sensor, and a printed circuit board. The actuator further comprises a cover and a base housing. The thrust support for the output shaft is in the cover housing. The gear train comprises a plurality of spur gears with hub teeth and external teeth. The worm meshes with the external teeth of the first spur gear of the gear train to cause its rotation. The hub teeth of the first spur gear mesh with the external teeth of the second spur gear causing its rotation. The hub teeth of the final spur gear in the gear train mesh with the teeth of the output gear causing its rotation. The output gear is connected to a driver and therefore, the rotation of the output gear causes the rotation of the driver. The driver then moves the flaps in the heater, ventilator and air conditioning system.

The optical sensor monitors the rotational position of the driver because the teeth of the output gear mesh with the teeth of the sensor gear shaft on which the optical sensor is operatively connected. The optical sensor is directly connected to the printed circuit board which stores the rotational position of the driver. The printed circuit board also stores the position of the flap by referencing the stored rotational position of the driver. Therefore, the printed circuit board uses this stored information to control the motor.

It is the purpose of the present invention to provide an electric motor actuator deigned for heater, ventilator and air-conditioning systems with higher efficiency and higher reliability.

It is further the purpose of the present invention to provide an electric motor actuator designed for heater, ventilator and air-conditioning systems that is simple and affordable to manufacture.

It is further the purpose of the present invention to provide an electric motor actuator with memory system compatibility.

It is further the purpose of the present invention to reduce the noise associated with electric motor actuators designed for heater, ventilator and air-conditioning systems.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a top view of the actuator with the housing;

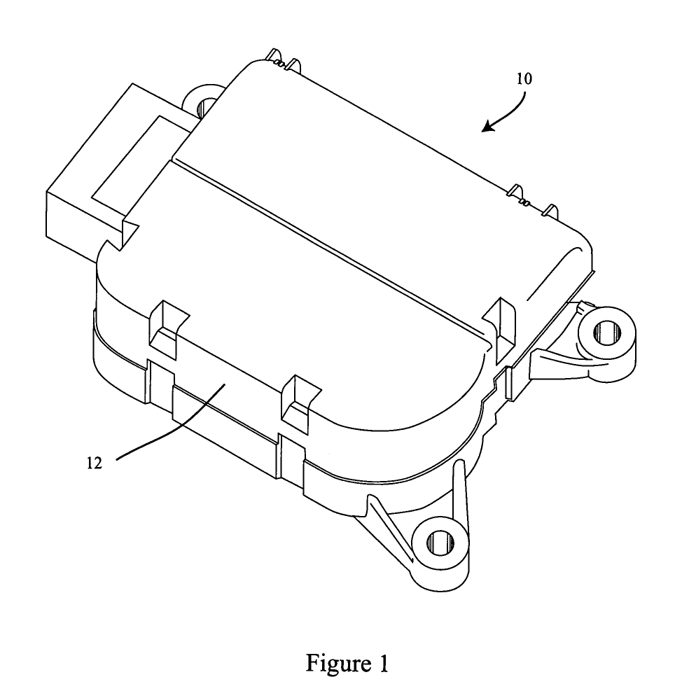

FIG. 2 illustrates a top view of the actuator with the top of the housing cut away to show the motor and gear train; and

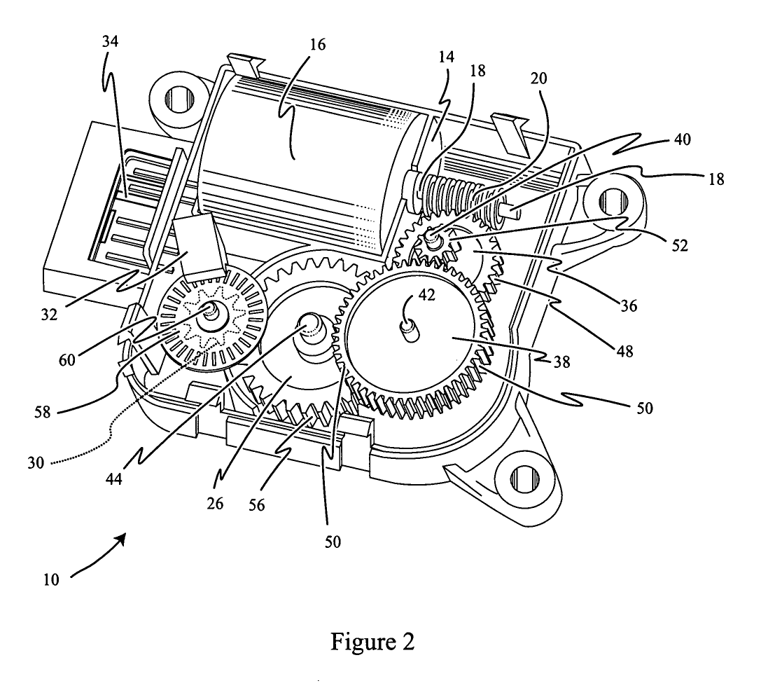

FIG. 3 illustrates a number of views of the worm, intermediate, and output gear.

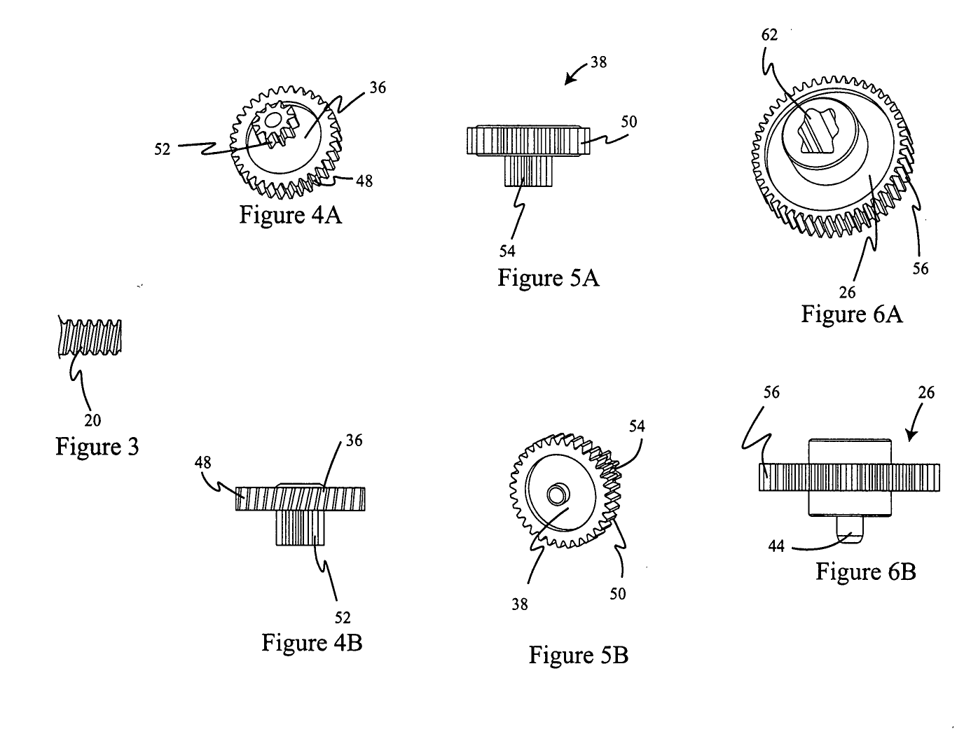

### DETAILED DESCRIPTION OF THE PREFERRED EMBODIMENTS

Referring to the accompanying drawings in which like reference numbers indicate like elements, the preferred embodiment of the actuator (10) generally includes a housing (12) with a thrust support (14), an electric motor (16) having an output shaft (18), a worm (20) rotatable with the output shaft (22), a gear train (24), an output gear (26), a driver (28), a sensor gear (30), an optical encoder (32), a printed circuit board (34). The gear train includes a worm gear (36) and an internal gear (38). The worm gear (36), internal gear (38), and output gear (26) are each rotatably mounted on gear shafts (40, 42, 44). The sensor gear is rotatably mounted on a sensor gear shaft (46).

In the preferred embodiment, the electric motor (16) causes the rotation of its output shaft (18) which in turn causes the rotation of the worm (20). The worm gear (36) and the internal gear (38) have external teeth (48, 50) and hub teeth (52, 54). In the preferred embodiment, the worm (20) meshes with the external teeth (48) of the worm gear (36) causing its rotation. The hub teeth (52) of the worm gear (36) mesh with the external teeth (50) of the internal gear (38) causing its rotation. This gear assembly provides less vibration and lower noise than other known actuators.

In the preferred embodiment, the hub teeth (54) of the internal gear (38) mesh with the teeth (54) of the output gear (26). The teeth (54) of the output gear (26) also mesh with the teeth (56) of the sensor gear (30) causing its rotation on the sensor gear shaft (60). A sensor wheel (58) is also rotatably mounted on the sensor gear shaft (60). Therefore, the rotation of the sensor gear (30) causes the rotation of the sensor gear shaft (60) and therefore, the sensor wheel (58). The sensor wheel (58) has a number of slots in its diameter that are detected by an optical encoder (32). Therefore, the optical encoder (32) is operatively connected to the sensor wheel (58) to track its rotation. The optical encoder (32) is also arranged on a printed circuit board (34) so that the sensor wheel's rotation may be recorded by the printed circuit board (34).

In the preferred embodiment, the output gear (26) has a hollowed portion (60) at its center for receiving the driver (28). Upon rotation of the output gear (26), the driver (28) rotates thereby moving flaps to control the air flow in the heater, ventilator and air-conditioning system. The printed circuit board (34) detects the position of the flaps by recording the rotation of the sensor wheel (58). The printed circuit (34) controls the motor (16) based on the position of the flaps. This simplified process is affordable and provides higher reliability due to the optical encoder (32) being directly connected to the printed circuit board (34). The actuator also provides for more simplified process and for convenient assembly which lowers the cost of manufacturing the actuator.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. For example, although the present invention is designed with the use of an optical encoder to detect the rotation of the sensor wheel, the invention may also be designed with a Hall sensor for detecting the sensor wheel's rotation. In this embodiment, the sensor wheel has a plurality of magnetized points on its diameter that are detected by the Hall sensor. Thus, the breadth and scope of the present invention should not be limited by any of the above-described exemplary embodiments, but should be defined only in accordance with the following claims appended hereto and their equivalents.

1. An actuator comprising:
a housing, wherein said housing further comprises a thrust support;
an electric motor disposed in said housing, wherein said motor further comprises a shaft;
a worm gear operatively connected to said motor;
a gear train disposed in said housing, said gear train comprising a set of spur gears, wherein said worm gear drives at least one of said spur gears;
an output gear disposed in said housing, wherein at least one of said spur gears drives said output gear; and
a driver operatively connected to said output gear.

2. The actuator as in claim 1 further comprising a sensor gear wherein said output gear drives said sensor gear.

3. The actuator as in claim 2 further comprising a sensor wheel wherein said sensor wheel is operatively connected to said sensor gear.

4. The actuator as in claim 3 further comprising an optical encoder wherein said optical encoder is operatively connected to a printed circuit board.

5. The actuator as in claim 3 wherein said sensor wheel comprises magnetized points.

6. The actuator as in claim 5 further comprising a Hall sensor wherein said Hall sensor is operatively connected to a printed circuit board.

7. An actuator comprising:
a housing, wherein said housing further comprises a thrust support;
an electric motor disposed in said housing;
an output shaft operatively connected to said motor,
a worm, said worm being rotatable with said output shaft;
a worm gear rotatable on a gear shaft having external teeth and hub teeth wherein said worm meshes with said external teeth of said worm gear;
an internal gear rotatable on a gear shaft having external teeth and hub teeth wherein said hub teeth of said worm gear mesh with said external teeth of said internal gear;
an output gear rotatable on a gear shaft having teeth wherein said hub teeth of said internal gear mesh with said teeth of said output gear;
a sensor gear rotatable on a sensor gear shaft having teeth wherein said teeth of said output gear mesh with said teeth of said sensor gear;
a sensor wheel, wherein said sensor wheel is operatively connected to said sensor gear shaft;
a printed circuit board, wherein said optical encoder is operatively connected to said printed circuit board; and
a driver, said driver is operatively connected to said output gear.

8. The actuator as in claim 7 wherein said sensor wheel comprises a plurality of slots.

9. The actuator as in claim 8 further comprising an optical encoder wherein said optical encoder is operatively connected to said printed circuit board.

10. The actuator as in claim 7 wherein said sensor wheel comprises a plurality of magnetized points.

11. The actuator as in claim 10 further comprising a Hall sensor wherein said Hall sensor is operatively connected to said printed circuit board.

12. An actuator comprising:
a housing, wherein said housing further comprises a thrust support an electric motor disposed in said housing;
an output shaft operatively connected to said motor, said output shaft containing a worm rotatable with said output shaft;
a gear train disposed in said housing, said gear train comprised of a plurality of spur gears having external teeth and hub teeth wherein said worm meshes with the external teeth of a first spur gear and the hub teeth of said first spur gear mesh with the external teeth of a second spur gear;
an output gear having teeth, said output gear is driven by the hub teeth of one of said spur gears;
a driver, said driver is operatively connected to said output gear.

13. The actuator as in claim 12 further comprising a sensor gear having teeth and rotatable on a sensory gear shaft wherein said teeth of said output gear mesh with said teeth of said sensor gear causing its rotation.

14. The actuator as in claim 13 further comprising a sensor wheel wherein said sensor wheel is rotatably mounted on said sensor gear shaft.

15. The actuator as in claim 14 further comprising an optical encoder wherein said optical encoder detects the rotation of said sensor wheel.

16. The actuator as in claim 15 further comprising a printed circuit board wherein said optical encoder is operatively connected to said printed circuit board.

17. The actuator as in claim 13 further comprising a Hall encoder wherein said Hall encoder detects the rotation of said sensor wheel.

18. The actuator as in claim 17 further comprising a printed circuit board wherein said Hall encoder is operatively connected to said printed circuit board.
